(19) United States
(12) Patent Application Publication
(10) Pub. No.: US 2013/0232481 A1
(43) Pub. Date: Sep. 5, 2013

(54) INFORMATION PROCESSING APPARATUS AND CLIENT MANAGEMENT METHOD

(71) Applicants: Takumi Yamashita, Hamura-shi (JP); Akane Nakamura, Ome-shi (JP)

(72) Inventors: Takumi Yamashita, Hamura-shi (JP); Akane Nakamura, Ome-shi (JP)

(21) Appl. No.: 13/609,539

(22) Filed: Sep. 11, 2012

(30) Foreign Application Priority Data
Mar. 5, 2012 (JP) 2012-047871

(51) Int. Cl. G06F 9/445

(52) U.S. Cl. 717/177

(57) ABSTRACT

According to one embodiment, an information processing apparatus manages one or more client terminals on a network in units of a group. The apparatus includes a file generator, a receiver and an information generator. The file generator generates a file including a program including causing a terminal to install agent software, and causing the terminal to transmit information indicating a group, to which the terminal belongs, to the apparatus. The receiver receives, when the program is executed with use of the file by a first terminal of the terminals, first information indicating a group to which the first terminal belongs. The information generator generates client information including information indicating the first terminal and the first information.

### CROSS-REFERENCE TO RELATED APPLICATIONS

This application is based upon and claims the benefit of priority from Japanese Patent Application No. 2012-047871, filed Mar. 5, 2012, the entire contents of which are incorporated herein by reference.

### FIELD

Embodiments described herein relate generally to an information processing apparatus which manages a client terminal, and a client management method applied to the apparatus.

### BACKGROUND

In recent years, in various kinds of companies, a system (client management system) for managing, by a server, many client terminals (client computers) in offices has been introduced.

In the client management system, the desktop environments (operating systems, applications) of many client terminals can be centrally managed by a server in the client management system. By the central management, many client terminals can efficiently be managed.

In the client management system, in some cases, such a method is adopted that all client terminals are not individually managed, but the client terminals are divided into some groups and the client terminals are managed in units of a group. In this method, for example, different operations can be performed in the individual groups, and administrators can be assigned to the individual groups.

In the method of managing client terminals in units of a group, a work of dividing the client terminals into groups is required. However, when the number of client terminals has increased, the cost that is required for the work of dividing the client terminals into groups increases.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary conceptual view illustrating an example of a client management system including an information processing apparatus according to an embodiment.

FIG. 2 is an exemplary conceptual view for explaining the configuration of an agent installer package which is delivered in the client management system shown in FIG. 1.

FIG. 3 is an exemplary block diagram illustrating an example of the configuration of a client terminal and the information processing apparatus (management server) of the embodiment.

FIG. 4 is an exemplary conceptual view for explaining examples of groups for managing client terminals by the information processing apparatus (management server) of the embodiment.

FIG. 5 is an exemplary view illustrating a configuration example of group information which is used by the information processing apparatus (management server) of the embodiment.

FIG. 6 is an exemplary conceptual view for explaining examples of client terminals belonging to groups which are managed by the information processing apparatus (management server) of the embodiment.

FIG. 7 is an exemplary view illustrating a configuration example of client information which is used by the information processing apparatus (management server) of the embodiment.

FIG. 8 is an exemplary view illustrating an example of a group select screen displayed by the client terminal in the client management system of FIG. 1.

FIG. 9 is an exemplary view illustrating another example of the group select screen displayed by the client terminal in the client management system of FIG. 1.

FIG. 10 is an exemplary view illustrating another configuration example of the client information which is used by the information processing apparatus (management server) of the embodiment.

FIG. 11 is an exemplary view illustrating an example of a group input screen displayed by the client terminal in the client management system of FIG. 1.

FIG. 12 is an exemplary flowchart illustrating an example of the procedure of an installer generation process executed by the information processing apparatus (management server) of the embodiment.

FIG. 13 is an exemplary flowchart illustrating an example of the procedure of an agent install process executed by the client terminal provided in the client management system of FIG. 1.

FIG. 14 is an exemplary flowchart illustrating an example of the procedure of a client registration process executed by the information processing apparatus (management server) of the embodiment.

FIG. 15 is an exemplary flowchart illustrating another example of the procedure of the installer generation process executed by the information processing apparatus (management server) of the embodiment.

FIG. 16 is an exemplary flowchart illustrating another example of the procedure of the agent install process executed by the client terminal provided in the client management system of FIG. 1.

FIG. 17 is an exemplary flowchart illustrating another example of the procedure of the client registration process executed by the information processing apparatus (management server) of the embodiment.

FIG. 18 is an exemplary block diagram illustrating an example of the system configuration of the information processing apparatus (management server) of the embodiment.

FIG. 19 is an exemplary block diagram illustrating an example of the system configuration of the client terminal in the client management system of FIG. 1.

### DETAILED DESCRIPTION

Various embodiments will be described hereinafter with reference to the accompanying drawings.

In general, according to one embodiment, an information processing apparatus is configured to manage one or more client terminals on a network in units of a group. The information processing apparatus includes a file generator, an information receiver and a client information generator. The file generator is configured to generate a file including an installer program, wherein the installer program includes causing a client terminal to install agent software for managing the client terminal, and causing the client terminal to transmit information indicative of a group, to which the client terminal belongs, to the information processing apparatus. The information receiver is configured to receive, when the installer program is executed with use of the file by a first terminal of the one or more client terminals, first information transmitted from the first terminal, wherein the first information is indicative of a group to which the first terminal belongs. The client information generator is configured to generate client information including information indicative of the first terminal and the first information.

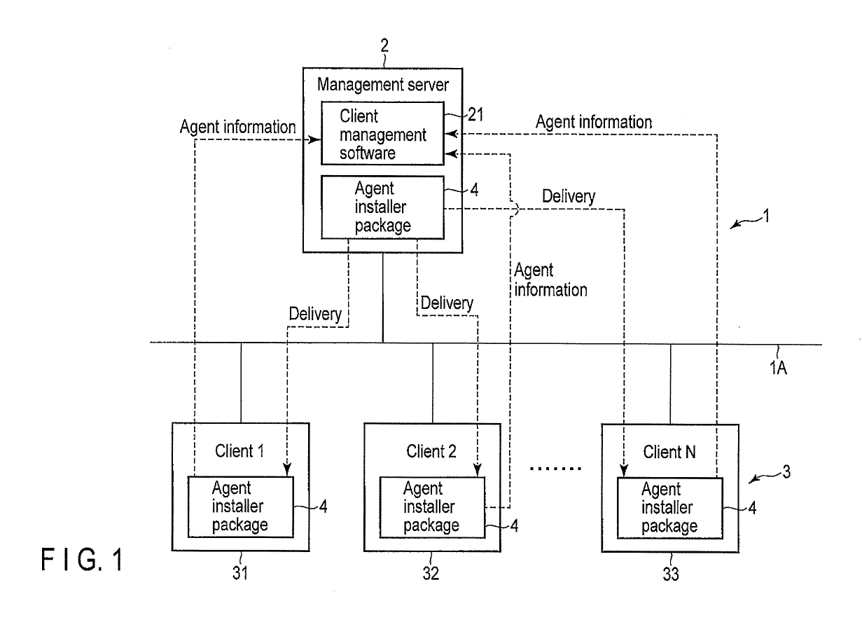

To begin with, referring to FIG. 1, a description is given of an example of a client management system 1 including an information processing apparatus according to an embodiment.

The client management system 1 is a client/server system in which a management server 2 and one or more clients 3 are interconnected via a network 1A. The management server 2 is realized, for example, as a server computer. The client 3 (client 31, 32, 33) is realized, for example, as a personal computer (PC). In addition, the client 3 may also be realized as a portable information terminal such as a thin client computer, a tablet PC, a PDA, a smartphone or a mobile phone.

The management server 2 manages the client 3. The management server 2 manages, for example, software which is installed in the client 3, such as an operating system (OS) and an application program. The management server 2 can also manage a file for updating an application program which has already been installed in the client 3, a security patch (a module for correcting weakness on security), a pattern file of antivirus software, etc.

The management server 2 executes client management software 21 for managing the client 3. Specifically, the client management software 21 includes a package generation function for generating an agent installer package 4 for installing agent software in the client 3. The generated agent installer package 4 is delivered to the client 3. The client management software 21 delivers the generated agent installer package 4 to the client 3 via the network 1A such as a LAN. Besides, the agent installer package 4 may be delivered to the client 3 by using a removable storage medium such as a USB flash memory.

The client 3 executes an installer program included in the agent installer package 4 that has been generated by the management server 2, thereby installing agent software on the client 3. The agent software is software for managing the client 3 in cooperation with the management server 2. Specifically, by the agent software having been installed in the client 3, the management server 2 can start the management of the client 3. The agent software includes, for example, a software management function for downloading data (file) from the management server 2, and installing new software on the client 3 or updating already installed software, by using the downloaded data.

In addition, when the agent software is installed, the installer program transmits information (agent information) relating to the client 3 to the management server 2 via the network 1A. The agent information includes, for example, identification information (e.g. a computer name or computer serial number) for identifying the client 3, and group information indicative of a group to which the client 3 belongs.

The client management software 21, which is executed on the management server 2, includes a client registration function for registering the client 3 by using the agent information which has been transmitted by the client 3 (the installer that is executed on the client 3). In the client registration function, for example, since the identification information of the clients 3 and the group information are associated when the clients 3 are registered, the management server 2 can manage registered clients 3 (i.e. clients 3 in which the agent software is installed) in units of a group.

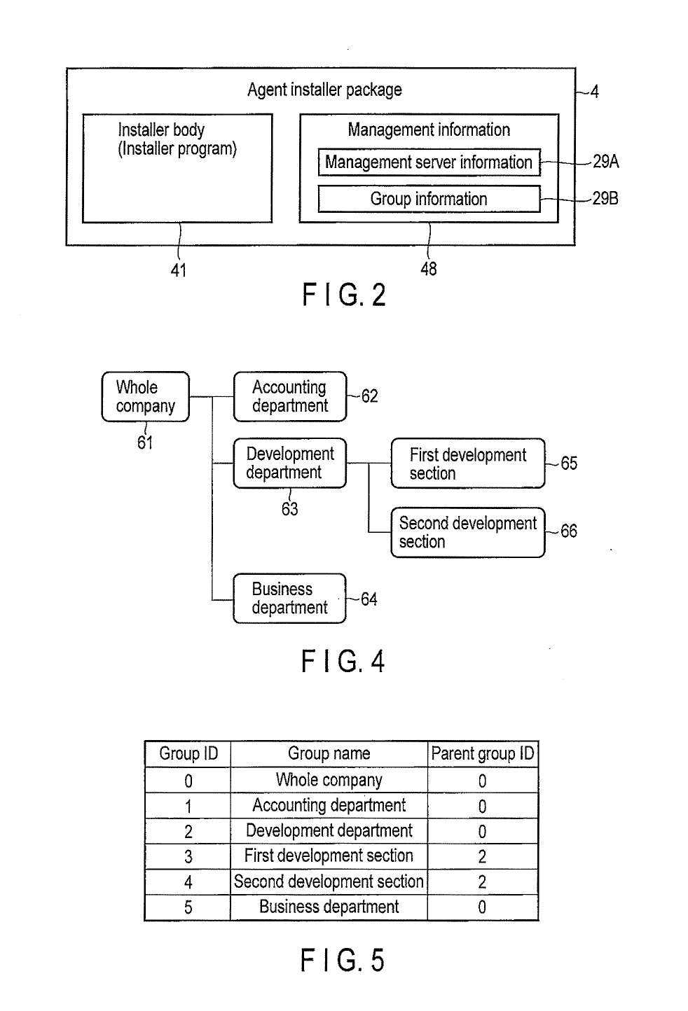

FIG. 2 illustrates a configuration example of the agent installer package 4 generated by the management server 2 (client management software 21).

The agent installer package 4 is, for example, a data file which includes an installer body (install program) 41 and management information 48. The management information 48 includes management server information 29A and group information 29B. The management server information 29A includes information for the client 3 to communicate with the management server 2. For example, the management server information 29A includes a server name and a port number of the management server 2. The group information 29B includes information which specifies one or more groups to which the client 3 may belong.

The installer program 41 includes an agent install function for installing the agent software in the client 3, as described above. In other words, the installer program 41 is executed on the client 3, and thereby the agent software is installed in the client 3. In addition, the installer program 41 includes an agent information transmission function for transmitting information (agent information) relating to the client 3 to the management server 2, when the agent software is installed. In this agent information transmission function, the installer program 41 transmits to the management server 2, for example, agent information including identification information (e.g. a computer name) of the client 3 and information indicative of the group to which the client 3 belongs. Using the agent information which has been transmitted by the client 3, the management server 2 generates information (client information) which is indicative of the client 3 that has transmitted the agent information, and the group to which this client 3 belongs, thereby registering the client 3 which is managed by the management server 2. Specifically, the management server 2 manages the client 3 as a client which belongs to the group is indicated in the agent information.

In addition, there is a method by a “questionnaire” system, in which after agent software is installed in the client, this agent software transmits the above-described agent information to the management server. In this method, in the management server, group information indicative of groups, to which the client may belong, is generated, and information indicative of the client, in which the agent software is operating, is registered. At this time point, the client has not been grouped. On the other hand, in the client, the agent software requests the management server to transmit group information, in response to the user's operation of the client. Using the group information which has been transmitted by the management server, the agent software displays on the screen a list of groups to which the client may belong, thereby prompting the user to select a group to which the client belongs. The agent software transmits information indicative of the selected group to the management server. Then, based on the information which has been transmitted by the client (agent software), the management server registers the group to which this client belongs.

However, in this method by the “questionnaire” system, there occurs a time period in which the client is not grouped, after the management of the client by the management server is started by the installation and execution of the agent software in the client. During this period, the client cannot be managed in units of a group. In addition, there is a possibility that until the user operates the client, the group is not selected and the period in which the client is not grouped continues.

Besides, there is a method by an installer system, in which agent installer packages including different group information pieces for individual groups are generated. In this method, in the management server, group information indicative of groups, to which the client may belong, is generated in advance. The management server selects one of the groups to which the client may belong, and generates an agent installer package including the group information corresponding to the selected group. Specifically, the management server generates an agent installer package including group information corresponding to each of the groups. In the client, by using the agent installer package including the group information of the group to which the client belongs, the installer of the agent software is executed. When the client is registered in the management server, the installed agent software transmits the group information, which is included in the agent installer package, to the management server. Thereby, based on the information that has been transmitted by the client (agent software), the management server can register the group to which this client belongs.

However, in this method by the installer system, agent installer packages need to be generated for respective groups, and it is time-consuming to execute management as to which installer package is to be delivered to which client.

Taking this into account, in the present embodiment, as described above, the information indicative of the group, to which the client 3 belongs, is transmitted from the client to the management server 2, while the agent software is being installed in the client 3. Using the transmitted information indicative of the group, the management server 2 registers the group to which the client 3 belongs. Then, in the client 3, the management of the client 3 by the cooperation between the agent software and the management server 2 (client management software 21) is started, in response to the registration by the management server 2 of the group to which the client belongs and the completion of the installation of the agent software. Thereby, in the management server 2, the client 3 can be managed in units of a group, without the administrator performing the work of registering the group to which the client 3 belongs.

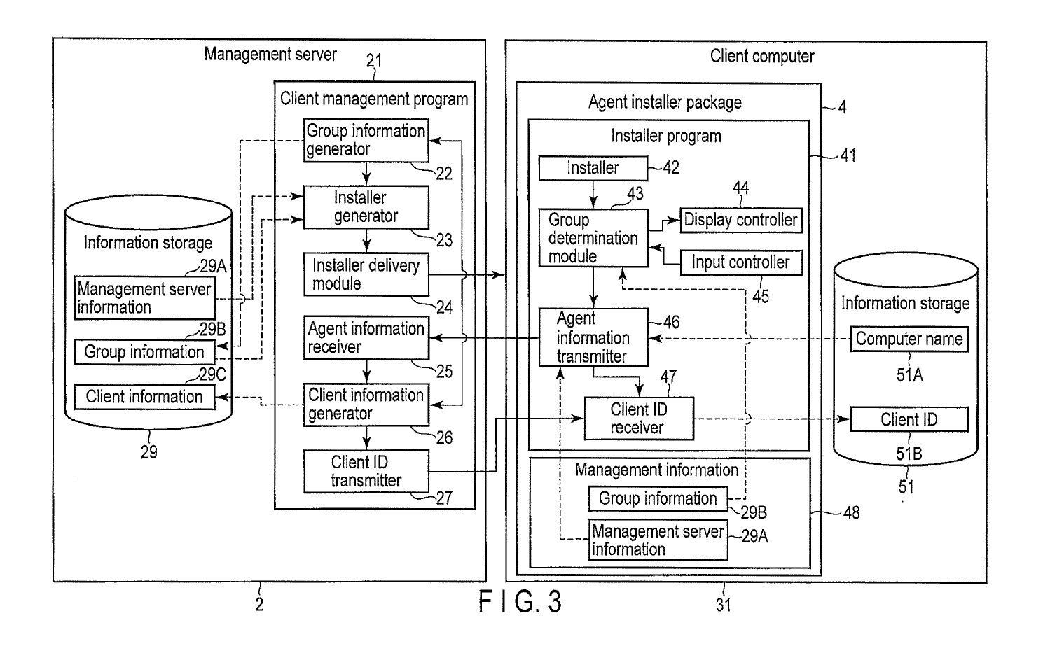

FIG. 3 illustrates an example of the configuration of the management server 2 and client terminal (client computer) 31, which are provided in the client management system 1. The management server 2 manages one or more client terminals 31 on the network in units of a group. The management server 2 executes the client management program 21. The client management program 21 includes, for example, a group information generator 22, an installer generator 23, an installer delivery module 24, an agent information receiver 25, a client information generator 26, and a client ID transmitter 27.

To begin with, the group information generator 22 generates group information 29B. The group information generator 22 generates the group information 29B, for example, in response to an operation by the administrator who uses the management server 2. For example, in accordance with the hierarchical structure of departments/sections in a company, the group information generator 22 generates the group information 29B which is indicative of groups having the hierarchical structure. The group information 29B is stored in an information storage 29 (e.g. a storage device provided in the management server 2).

FIG. 4 shows examples of groups which are hierarchically organized, as in the case of a hierarchical structure of departments/sections in a company. The hierarchical groups (hereinafter also referred to as “group tree”) have relationships form a branching, treelike structure. In the hierarchical groups, a “child” group may be set for a “parent” group which is an upper-layer group. In the example shown in FIG. 4, with a “whole company” group 61 being set as a “parent”, three “child” groups, namely an “accounting department” group 62, a “development department” group 63 and a “business department” group 64, are set. In addition, with the “development department” group 63 being set as a “parent”, two “child” groups, namely a “first development section” group 65 and a “second development section” group 66, are set.

FIG. 5 illustrates an example of the group information 29B corresponding to the hierarchical groups shown in FIG. 4. The group information 29B includes a plurality of entries corresponding to a plurality of groups. Each entry includes, for example, a group ID, a group name, and a parent group ID. In an entry corresponding to a certain group, “Group ID” is indicative of identification information which is given to the group. “Group name” is indicative of the name of the group. “Parent group ID” is indicative of a group ID which is given to a “parent” group of this group. Incidentally, in an entry in which a group has no “parent” group or in an entry corresponding to an uppermost-layer group (“whole company” group 61 in FIG. 4), the ID of this group itself, for example, is set in the “Parent group ID”.

By referring to the group information 29B, it is understood, for example, that the parent group of the “accounting department” group 62 is the “whole company” group 61, the group ID of which is “0”. In addition, it is understood, for example, that the parent group of the “first development section” group 65 and “second development section” group 66 is the “development department” group 63, the group ID of which is “2”.

Accordingly, for example, when the group name of a certain group and the information indicative of an upper-layer group of this certain group (e.g. a parent group name or a parent group ID) have been input by the administrator, the group information generator 22 generates an entry of the group information 29B which corresponds to this group by using the input information, and adds the generated entry to the group information 29B. In the meantime, the group information generator 22 can also alter the description of the entry in the group information 29B, or delete the entry.

In addition, the installer generator 23 generates an agent installer package 4 including an installer program. The installer program includes causing the client terminal 31 to install agent software in the client terminal 31 and causing the client terminal 31 to transmit agent information relating to the client terminal 31, to the management server 2. The agent information is, for example, information indicative of the computer name of the client terminal 31 and a group to which the client terminal 31 belongs. The agent installer package 4 includes, for example, the installer program 41 for installing the agent software and transmitting the agent information, the group information 29B which has been generated by the group information generator 22, and the management server information 29A for accessing the management server 2. The installer generator 23 outputs the generated agent installer package 4 to the installer delivery module 24.

The installer delivery module 24 delivers the output agent installer package 4 to the client terminal 31. The installer delivery module 24 delivers the agent installer package 4 to the client terminal 31 via the network 1A such as a LAN. In the meantime, the agent installer package 4 may be delivered to the client terminal 31 by using a removable storage medium such as a USB flash memory.

In the client terminal (client computer) 31, for example, the installer program 41 in the delivered agent installer package 4 is executed on the operating system (OS). The execution of the installer program 41 is started, for example, in response to the boot of the OS, the reception of the agent installer package 4, or a predetermined operation by the user. The installer program 41 includes an installer 42, a group determination module 43, a display controller 44, an input controller 45, an agent information transmitter 46, and a client ID receiver 47.

The installer 42 installs the agent software on the client terminal 31. The agent software, for example, in cooperation with the management server 2 (client management program 21), manages the OS and application program which are used in the client terminal 31. To be more specific, the agent software requests the management server 2 for the delivery of data for executing the OS and application program (e.g. a disk image), and data for updating the OS and application program (e.g. a file for correcting a bug in the program, a security patch (a module for correcting weakness on security), a pattern file of antivirus software, etc.). Then, the agent software receives the data delivered from the management server 2, and executes a predetermined process by using the received data. Thereby, in the client terminal 31, the delivered OS and application program can be used, and various updates can be applied to the programs that are executed on the client terminal 31.

In addition, while the installer program 41 is being executed, the group determination module 43 determines a group to which the client terminal 31 belongs. The group determination module 43 prompts the user to select the group to which the client terminal 31 belongs, for example, while the agent software is being installed by the installer 42 (i.e. in parallel with the installation), or before the installation or after the installation.

To be more specific, the group determination module 43 requests the display controller 44 to display a user interface such as a screen for selecting a group. Responding to the request by the group determination module 43, the display controller 44 displays, on a display device, a screen for prompting the user to select the group to which the client terminal 31 belongs, for example, by using the group information 29B included in the agent installer package 4.

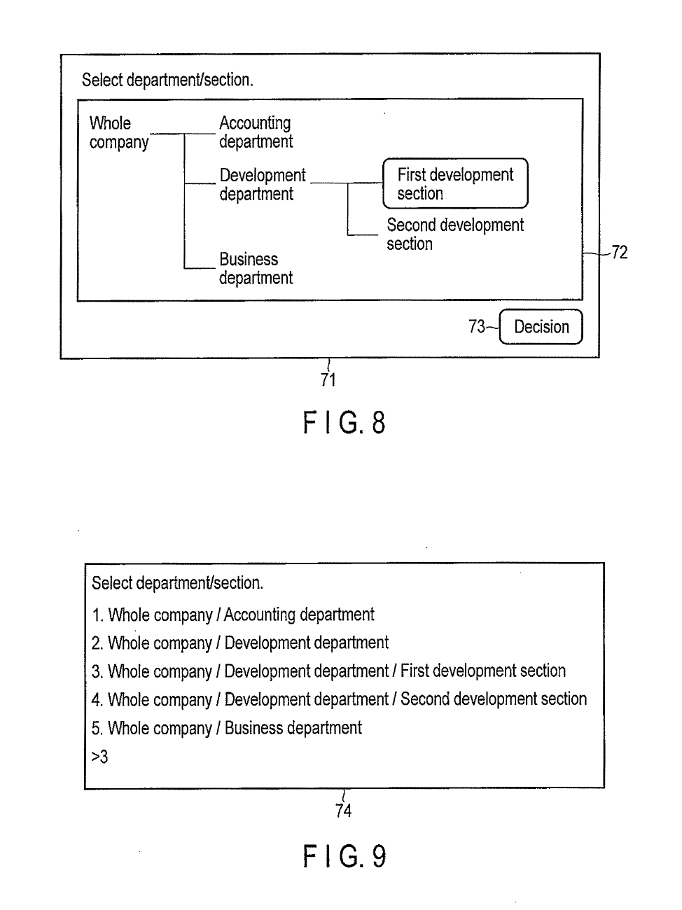

The input controller 45 detects an input (i.e. a user operation of selecting a group) on the displayed screen with use of a pointing device such as a keyboard or a mouse, and outputs a description of the detected input to the group determination module 43. Based on the description of the detected input and the group information 29B, the group determination module 43 detects a group ID corresponding to the group to which the client terminal 31 belongs. Then, the group determination module 43 outputs the detected group ID to the agent information transmitter 46. In the meantime, an example of the screen for prompting the user to select a group will be described later with reference to FIGS. 8 and 9.

The agent information transmitter 46 transmits to the management server 2 (agent information receiver 25) the agent information indicative of the group ID output by the group determination module 43, and a computer name 51A of the client terminal 31 stored in an information storage 51.

The agent information receiver 25 of the management server 2 receives the agent information transmitted from the client terminal 31 (agent information transmitter 46). Then, the agent information receiver 25 outputs the received agent information to the client information generator 26.

Responding to the output of the agent information from the agent information receiver 25, the client information generator 26 generates a client ID for the client terminal 31 which transmitted the agent information. The client ID is identification information which is given to the client terminal 31. The client information generator 26 generates client information 29C by using the generated client ID and the agent information. Specifically, the client information generator 26 generates an entry of the client information 29C which includes the client ID, the computer name of the client terminal 31, and the group ID of the group to which the client terminal 31 belongs. In other words, the client information generator 26 associates, by the generated entry, the client terminal 31 with the group to which the client terminal 31 belongs. The client information generator 26 adds the generated entry to the client information 29C stored in the information storage 29. Then, the client information generator 26 outputs the generated client ID to the client ID transmitter 27.

The client ID transmitter 27 transmits the output client ID to the client terminal 31 (client ID receiver 47), thereby to notify the completion of the registration process by the management server 2 (i.e. the completion of the generation of the corresponding client information 29C). Incidentally, the client ID transmitter 27 may simply notify the client terminal 31 that the registration by the management server 2 has been completed, without transmitting the client ID.

The client ID receiver 47 of the client terminal 31 receives the client ID which has been transmitted from the management server 2. Then, the client ID receiver 47 stores the received client ID 51B in the information storage 51. Incidentally, the client ID receiver 47 may receive a notification indicative of the completion of the registration process from the management server 2. The execution of the agent software, which has been installed in the client terminal 31, is started after the completion of the registration process by the management server 2 (i.e. after the reception of the client ID which has been transmitted from the management server 2). Thereby, the management server 2, in cooperation with the agent software that is being executed, can manage the client terminal 31, based on the registered group.

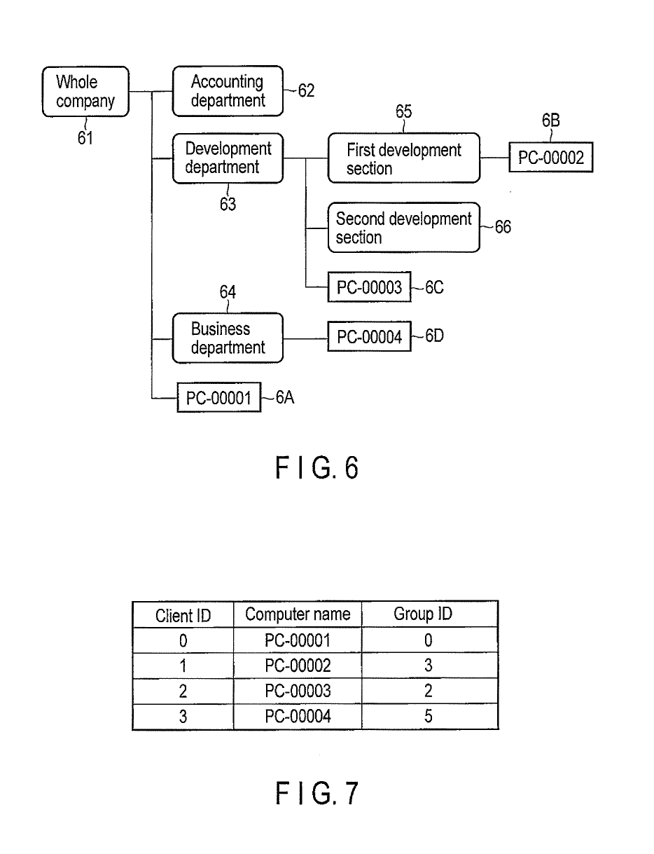

FIG. 6 shows examples of client terminals belonging to groups which are hierarchically organized. In the examples shown in FIG. 6, a client terminal (PC-00001) 6A belongs to the “whole company” group 61, a client terminal (PC-00002) 6B belongs to the “first development section” group 65, a client terminal (PC-00003) 6C belongs to the “development department” group 63, and a client terminal (PC-00004) 6D belongs to the “business department” group 64.

FIG. 7 shows an example of the client information 29C corresponding to the client terminals 6A to 6D which belong to the hierarchical groups in FIG. 6. The client information 29C includes a plurality of entries corresponding to a plurality of client terminals. Each entry includes, for example, a client ID, a computer name, and a group ID. In an entry corresponding to a certain client terminal, “Client ID” is indicative of identification information which is given to the client terminal. “Computer name” is indicative of a name given to the client terminal. “Group ID” is indicative of a group ID of a group to which the client terminal belongs.

By referring to the client information 29C and group information 29B, it is understood that, for example, the client terminal 6A, whose computer name is “PC-00001”, belongs to the “whole company” group 61 whose group ID is “0”. In addition, it is understood that, for example, the client terminal 6B, whose computer name is “PC-00002”, belongs to the “first development section” group 65 whose group ID is “3”.

Accordingly, for example, when the agent information has been transmitted by the client terminal 31, the client information generator 26 generates the entry of the client information 29C, which corresponds to the client terminal 31, by using this agent information, and adds the generated entry to the client information 29C. In the meantime, the client information generator 26 can also alter the description of the entry in the client information 29C, or delete the entry.

FIG. 8 illustrates an example of a group select screen displayed by the installer program 41 (display controller 44). A group select screen 71 of this example is a graphical user interface (GUI) including buttons 72 of a tree structure based on the group information 29B, and a decision button 73.

The user selects a button corresponding to a group (“first development section” in this example) to which the client terminal that is being used belongs, and then presses the decision button 73. Responding to this operation, the group determination module 43 determines the group to which the client terminal belongs.

FIG. 9 illustrates another example of the group select screen displayed by the installer program 41 (display controller 44). A group select screen 74 of this example is a character user interface (CUI) in which text indicative of correspondence between a number and a group (e.g. “3. Whole company/development department/first development section”) is displayed, and a prompt, which prompts the user to input the number corresponding to the group, to which the client terminal that is being used belongs, is displayed.

By using the keyboard, for example, the user inputs the number corresponding to the group to which the client terminal that is being used belongs (e.g. the number “3” corresponding to the “first development section”). Responding to this operation, the group determination module 43 determines the group to which the client terminal belongs.

By the above-described configuration, when the management server 2 manages the client terminal 3 in units of a group, the group to which the client terminal 3 belongs can easily be registered. In the present embodiment, when the group to which the client terminal 3 belongs is to be registered (i.e. when the client information 29C of the client terminal is to be generated), for example, the administrator of the management server 2 does not input the information for grouping the client terminals 3, but the user who uses each client terminal 3 is prompted to select the group to which this computer belongs. Therefore, the cost of the work by the administrator can be reduced. In addition, after the group to which the client terminal 3 belongs is registered in the management server 2, the agent software is executed on the client terminal 3, and the management of the client terminal 3 by the management server 2 is started. Thus, the management server 2 can manage the client terminal 3 in units of a group at a time when the management is started. In addition, the management server 2 does not need to generate the agent installer package on a group-by-group basis.

In the meantime, in the client terminal 31, there is a case in which the OS is executed on a virtual machine. In the client terminal 31 which executes the OS on the virtual machine, a hypervisor, which is software for managing the virtual machine, is installed. In the client terminal 31, after the hypervisor has been installed, an OS of any kind is installed on the virtual machine. In the present embodiment, the above-described agent software may be incorporated in the hypervisor.

In this case, the installer generator 23 of the management server 2 generates, for example, a hypervisor installer package including an installer program for installing a hypervisor in which a module corresponding to the agent software is incorporated. Then, using network boot by PXE (preboot execution environment) or USB boot by a USB-connected storage device (e.g. USB flash memory), the installer delivery module 24 causes the client terminal 31 to execute the installer program. Thereby, the installer 42 of the client terminal 31 installs the hypervisor, in which the agent software is incorporated, on the client terminal 31, and the agent information transmitter 46 transmits the agent information to the management server 2 (agent information receiver 25).

In the meantime, since the computer name 51A is set, for example, at a time when the OS is installed, it is assumed that the computer name 51A is not set (not present) at a time when the hypervisor has been installed. In this case, instead of the computer name 51A, a serial number, which is unique to the client terminal 31, is included in the agent information which is transmitted from the client terminal 31 to the management server 2. The serial number can be acquired by using, for example, a desktop management interface (DMI), even before the OS is installed.

Then, the client information generator 26 of the management server 2 determines whether the client information 29C includes an entry, which includes the same serial number as the serial number in the agent information. When the client information 29C does not include the entry, a client ID corresponding to the client terminal 31, which has transmitted this agent information, is generated (i.e. a new entry of the client information 29 is generated).

On the other hand, when the client information 29C includes the entry, the client information generator 26 determines that the client terminal 31, which has transmitted this agent information, is an already registered computer, and does not generate a new client ID (i.e. does not generate a new entry of the client information 29C). Specifically, the entry of the client information 29C, which is indicative of the group to which the client terminal 31 belongs, is maintained. In the meantime, the generation of the entry, which is based on the determination as to whether an entry, which includes the same serial number as the serial number in the agent information, is included in the client information 29C, can similarly be executed by determination based on the computer name.

Information, such as a serial number, which can be acquired by using the DMI, does not depend on the OS that is installed on the client terminal 31, and is not altered even if the hypervisor or OS has been re-installed or if the computer name 51A has been changed. Thus, when the client information generator 26 receives agent information which has been transmitted from a certain client terminal 31 and an entry including a serial number in this agent information is included in the client information 29C, the client information generator 26 determines that this client terminal 31 is a computer which has already been registered in the management server 2 (i.e. a computer to which the client ID has already been given). In this case, the client information generator 26 does not issue a new client ID, and the entry is maintained as is. Therefore, by using the serial number, the client information 29C indicative of the group, to which the client terminal 31 belongs, can be maintained even if the hypervisor or OS has been re-installed or if the computer name 51A has been changed.

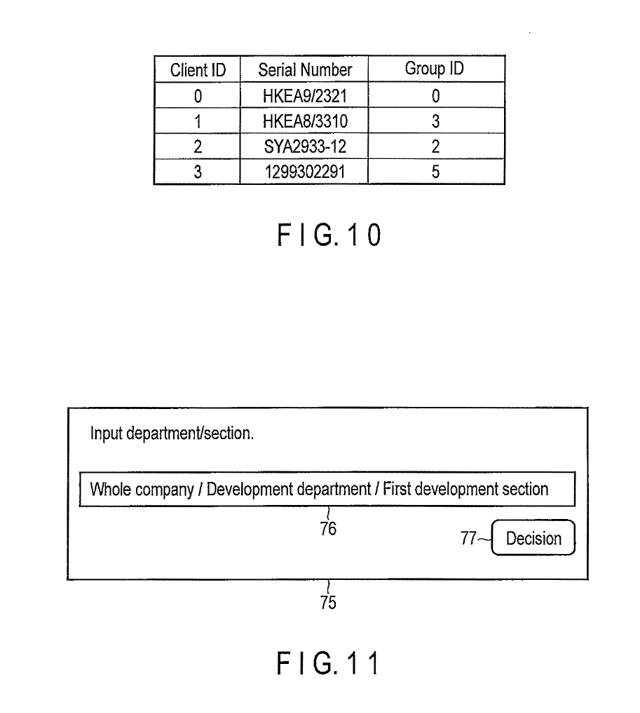

FIG. 10 illustrates a configuration example of the client information 29C which has been generated by using the agent information including the serial number of the client terminal 31.

This client information 29C includes a plurality of entries corresponding to a plurality of client terminals. Each entry includes, for example, a client ID, a serial number, and a group ID. In an entry corresponding to a certain client terminal, “Client ID” is indicative of identification information which is given to the client terminal. “Serial number” is indicative of a serial number which is given to the client terminal. “Group ID” is indicative of a group ID of a group to which the client terminal belongs.

By referring to the client information 29C and group information 298, it is understood that, for example, a client terminal, whose serial number is “HKEA9/2321”, belongs to the “whole company” group 61 whose group ID is “0”. In addition, it is understood that, for example, a client terminal, whose serial number is “HKEA8/3310”, belongs to the “first development section” group 65 whose group ID is “3”. In the meantime, regardless of whether the computer name 51 is set in the client terminal 31 or not, the agent information including the serial number of the client terminal 31 may be transmitted to the management server 2, and the client information 29C including this serial number may be generated.

In addition, in the above-described management server 2, the group information 29B is generated in advance in accordance with, e.g. an input by the administrator. However, when the number of groups is large, the administrator needs to execute an input which requires a great deal of time and labor, in order to generate the group information 29B. Thus, in the management server 2, the user of the client terminal 31 may be caused to input the name of the group to which this computer 31 belongs, and the management server 2 may also generate the group information 29B by using the input name.

When the user of the client terminal 31 is caused to input the name of the group to which this computer 31 belongs, the group determination module 43 requests the display controller 44 to display a group input screen for inputting the name of the group. Then, the input controller 45 detects an input on the group input screen with use of, e.g. the keyboard, and outputs the detected input description to the group determination module 43.

The name of a group, which the user is caused to input, is described, for example, in such a format that a path starting from an uppermost-layer group (“whole company”) to a lower-layer target group to a group, to which the client terminal 31 belongs, is divided by a slash mark “/” at each boundary between layers. In the description below, the name described in this format is also referred to as “hierarchical group name”. Accordingly, the hierarchical group name includes one or more group names indicative of one or more groups having a hierarchical structure.

FIG. 11 illustrates an example of the group input, screen displayed by the display controller 44. A group input screen 75 of this example includes a group input area 76 and a decision button 77. The group input area 76 is an area for inputting the name of the group to which the client terminal that is being used belongs. In this group input area 76, for example, a hierarchical group name is input. In the example shown in FIG. 11, like a hierarchical group name “whole company/development department/first development section”, the name of the group is described in such a format that a path starting from an uppermost-layer group (“whole company”) to a lower-layer group (“development department”) to a group (“first development section”), to which the client terminal 31 belongs, is divided by a slash mark “/” at each boundary between layers.

The user inputs the hierarchical group name corresponding to the client terminal 31, which is being used, in the group input area 76 by using the keyboard or the like, and then presses the decision button 77. Responding to this operation, the group determination module 43 outputs the input hierarchical group name to the agent information transmitter 46. The agent information transmitter 46 transmits to the management server 2 the agent information including the output hierarchical group name, and the computer name 51A (or serial number) of the client terminal 31.

The agent information receiver 25 of the management server 2 receives the transmitted agent information. The agent information receiver 25 outputs the received agent information to the client information generator 26.

When a hierarchical group name is included in the agent information output by the agent information receiver 25, the client information generator 26 outputs the hierarchical group name to the group information generator 22.

Using the hierarchical group name output by the client information generator 26, the group information generator 22 determines whether each of one or more groups indicated in the hierarchical group name is present or not. To be more specific, the group information generator 22 determines, in the order from the upper-layer group name, whether the entry corresponding to each of the one or more groups indicated in the hierarchical group name is included in the group information 29B. For example, when the hierarchical group name is “whole company/development department/first development section”, the group information generator 22 determines whether the entries including the “whole company”, “development department” and “first development section”, respectively, are included in the group information 29B. In the meantime, the group information generator 22 may execute determination by also taking the upper-layer group into account, like a case of determining whether an entry including the “development department” whose parent group is the “whole company” group (e.g. an entry including the parent group ID “0” and including the “development department”) is included in the group information 29B.

If the entries corresponding to all the group names in the hierarchical group name are included in the group information 29B, the group ID of the entry corresponding to the group to which the client terminal 31 belongs (e.g. the “first development section” group in the hierarchical group name “whole company/development department/first development section”) is output to the client information generator 26.

On the other hand, when the one or more group names in the hierarchical group name include a group name, the corresponding entry of which is not included in the group information 29B, the group information generator 22 generates an entry of the group information 29B, which corresponds to this group name. For example, when the group information 29B includes an entry (group ID=0) corresponding to the “whole company” but does not include an entry corresponding to the “development department”, the group information generator 22 generates an entry corresponding to the “development department”, without generating an entry corresponding to the “whole company”. The group information generator 22 generates, for example, an entry including the group ID “2”, group name “development department” and parent group ID “0”, as the entry corresponding to the “development department”, and adds this entry to the group information 29B. By executing a similar process with respect to each layer, it is possible to generate the group information 29B including one or more entries corresponding to one or more groups indicated in the hierarchical group name. Then, the group information generator 22 outputs to the client information generator 26 the group ID of the entry corresponding to the group to which the client terminal 31 belongs (e.g. the “first development section” group in the hierarchical group name “whole company/development department/first development section”).

The client information generator 26 generates the entry of the client information 29C, which corresponds to the client terminal 31, by using the group ID output by the group information generator 22, and the agent information generated by the agent information receiver 25. Specifically, the client information generator 26 generates a client ID of the client terminal 31 that has transmitted the agent information. The client information generator 26 generates an entry of the client information 29C, which includes the client ID, the computer name of the client terminal 31, and the group ID of the group to which the client terminal 31 belongs. The client information generator 26 adds the generated entry to the client information 29C which is stored in the information storage 29. Then, the client information generator 26 outputs the generated client ID to the client ID transmitter 27.

The client ID transmitter 27 transmits the client ID output by the client information generator 26, to the client terminal 31 (client ID receiver 47).

The client ID receiver 47 of the client terminal 31 receives the client ID transmitted from the management server 2. Then, the client ID receiver 47 stores the received client ID 51B in the information storage 51.

By the above-described configuration, when the management server 2 manages the client terminal 3 in units of a group, it is possible to easily execute the generation of the group information 29B indicative of one or more groups to which the client terminal 3 belongs, and the registration of the group to which the client terminal 3 belongs (i.e. the generation of the client information 29C). When the client terminal 3 belongs to a group which is not specified in the group information 29B, the management server 2 adds an entry corresponding to this group to the group information 29B, and thereafter registers the group to which the client terminal 3 belongs.

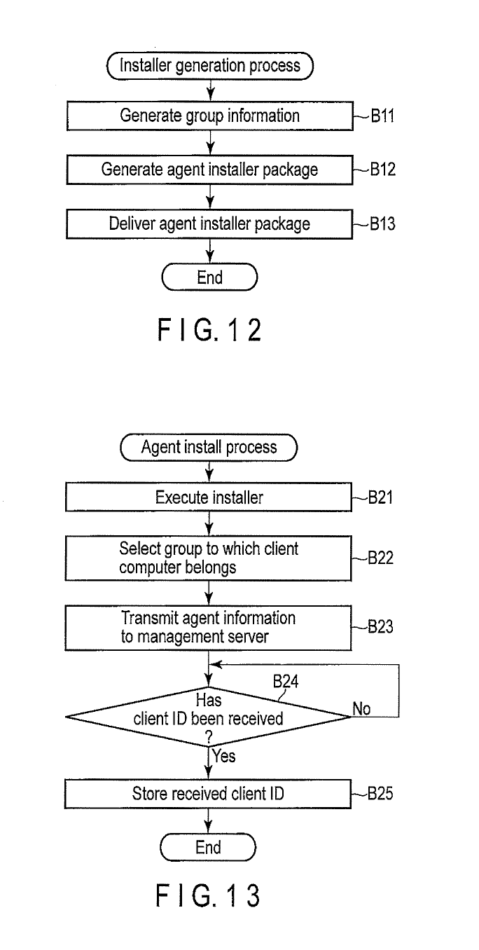

Next, referring to flowcharts of FIGS. 12 to 14, a description is given of examples of procedures at a time when the management server 2 registers the group to which the client terminal 3 belongs, upon receiving agent information including a group ID from the client terminal 3.

To begin with, referring a flowchart of FIG. 12, a description is given of an example of the procedure of an installer generation process executed by the management server 2.

To start with, the group information generator 22 generates group information 29B (block B11). The group information generator 22 generates the group information 29B, for example, in response to an operation by the administrator who uses the management server 2.

Then, the installer generator 23 generates an agent installer package 4 for installing agent software in the client 3 (block B12). The agent installer package 4 includes, for example, the installer program 41 for causing the client 3 to install the agent software, the generated group information 29B, and the management server information 29A including the server name of the management server 2 and the port number. The installer delivery module 24 delivers the generated agent installer package 4 to the client 3 (block B13).

FIG. 13 is a flowchart illustrating an example of the procedure of an agent install process executed by the client terminal 3.

To start with, the installer program 41, which is stored in the agent installer package 4, is executed, and thereby the installer 42 installs the agent software in the client terminal 31 (block B21).

Then, the group determination module 43 selects the group to which the client terminal 31 belongs (block B22). To be more specific, the group determination module 43 requests the display controller 44 to display a user interface such as a screen for selecting a group. The display controller 44 displays, on a display device, a screen for prompting the user to select the group, for example, by using the group information 29B in the agent installer package 4. The input controller 45 detects an input (i.e. a user operation of selecting a group) on the screen with use of a pointing device such as a keyboard or a mouse, and outputs the description of the detected input to the group determination module 43. Based on the description of the detected input and the group information 29B, the group determination module 43 detects a group ID corresponding to the group to which the client terminal 31 belongs. In the meantime, the selection of the group to which the client terminal 31 belongs may be executed in parallel, while the agent software is being installed.

The agent information transmitter 46 transmits to the management server 2 (agent information receiver 25) the agent information indicative of the computer name 51A of the client terminal 31, which is stored in the information storage 51, and the group ID of the group to which the client terminal 31 belongs (block B23).

Subsequently, the client ID receiver 47 determines whether the client ID has been received from the management server 2 (block B24). The client ID is identification information which is given to the client terminal 31 by the management server 2. When the client ID has not been received (NO in block B24), the process returns to block B24, and it is determined once again whether the client ID has been received from the management server 2. On the other hand, when the client ID has been received (YES in block B24), the client ID receiver 47 stores the received client ID 51B in the information storage 51 (block B25). In the client terminal 31, such control is executed that the use of the agent software is started, in response to the completion of installation of the agent software and the reception (storage) of the client ID.

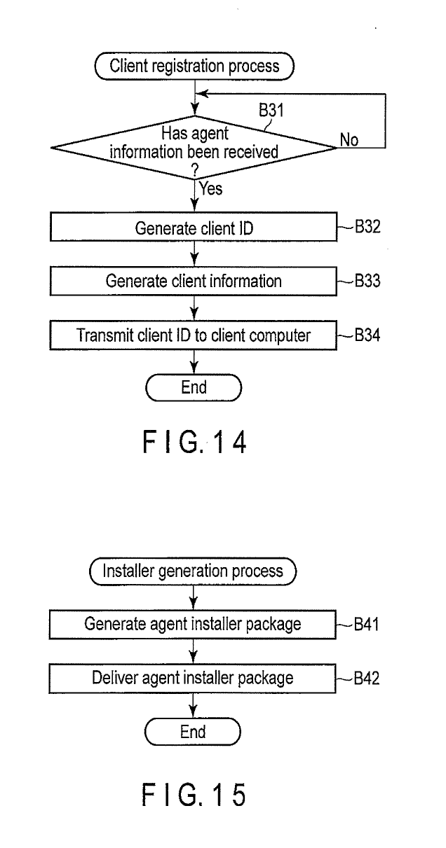

FIG. 14 is a flowchart illustrating an example of the procedure of a client registration process executed by the management server 2.

To start with, the agent information receiver 25 determines whether the agent information transmitted from the client terminal 31 (agent information transmitter 46) has been received (block B31). The agent information is indicative of, for example, the computer name 51A of the client terminal 31, and the group ID of the group to which the client terminal 31 belongs. When the agent information has not been received (NO in block B31), the process returns to block B31, and it is determined once again whether the agent information has been received from the client terminal 31.

On the other hand, when the agent information has been received (YES in block B31), the client information generator 26 generates a client ID which is to be given to the client terminal 31 which transmitted the agent information (block B32). Then, the client information generator 26 generates client information 29C by using the generated client ID and the agent information (block B33). Specifically, the client information generator 26 generates an entry of the client information 29C which includes the client ID, the computer name of the client terminal 31, and the group ID of the group to which the client terminal 31 belongs. The client information generator 26 adds the generated entry to the client information 29C stored in the information storage 29. In addition, the client ID transmitter 27 transmits the client ID to the client terminal 31 (client ID receiver 47) (block B34).

Next, referring to flowcharts of FIGS. 15 to 17, a description is given of examples of procedures at a time when the management server 2 registers the group to which the client terminal 3 belongs, while generating group information 29B, upon receiving agent information including a hierarchical group name from the client terminal 3. Thus, in this installer generation process, unlike the process described with reference to FIG. 12, it is assumed that the group information 29B is not generated in advance.

To begin with, referring a flowchart of FIG. 15, a description is given of an example of the procedure of an installer generation process executed by the management server 2.

To start with, the installer generator 23 generates an agent installer package 4 for installing agent software in the client 3 (block B41). The agent installer package 4 includes, for example, the installer program 41 for causing the client 3 to install the agent software, and the management server information 29A including the server name of the management server 2 and the port number. The installer delivery module 24 delivers the generated agent installer package 4 to the client 3 (block B42).

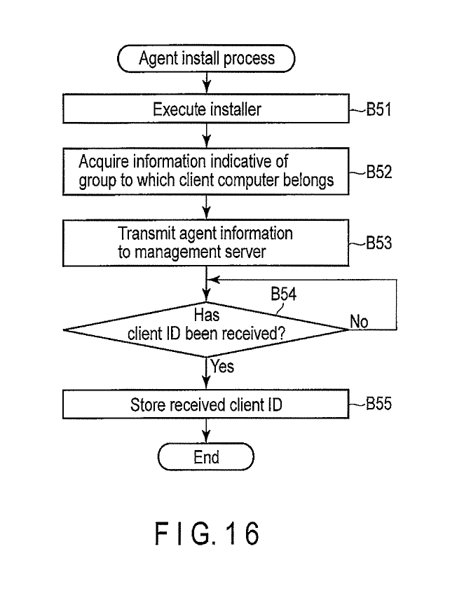

FIG. 16 is a flowchart illustrating an example of the procedure of an agent install process executed by the client terminal 3.

To start with, the installer program in the agent installer package is executed, and thereby the installer 42 installs the agent software in the client terminal 31 (block B51).

Then, the group determination module 43 acquires information indicative of the group to which the client terminal 31 belongs (block B52). To be more specific, the group determination module 43 requests the display controller 44 to display a user interface such as a screen for inputting the information indicative of the group. The display controller 44 causes the display device to display a screen for prompting the user to input the group name (e.g. the group name of the group to which the client terminal 31 belongs, or the hierarchical group name indicative of the hierarchical structure of the group to which the client terminal 31 belongs). The input controller 45 detects an input (i.e. a user operation of inputting the group name) on the screen with use of the keyboard, and outputs a description of the detected input to the group determination module 43. Based on the description of the detected input, the group determination module 43 detects a group name corresponding to the group to which the client terminal 31 belongs. In the meantime, the acquisition of the group name may be executed in parallel, while the agent software is being installed.

The agent information transmitter 46 transmits to the management server 2 (agent information receiver 25) the agent information indicative of the computer name 51A of the client terminal 31, which is stored in the information storage 51, and the group name of the group to which the client terminal 31 belongs (block B53).

Subsequently, the client ID receiver 47 determines whether the client ID has been received from the management server 2 (block B54). The client ID is identification information which is given to the client terminal 31 by the management server 2. When the client ID has not been received (NO in block B54), the process returns to block B54, and it is determined once again whether the client ID has been received from the management server 2. On the other hand, when the client ID has been received (YES in block B54), the client ID receiver 47 stores the received client ID 51B in the information storage 51 (block B55).

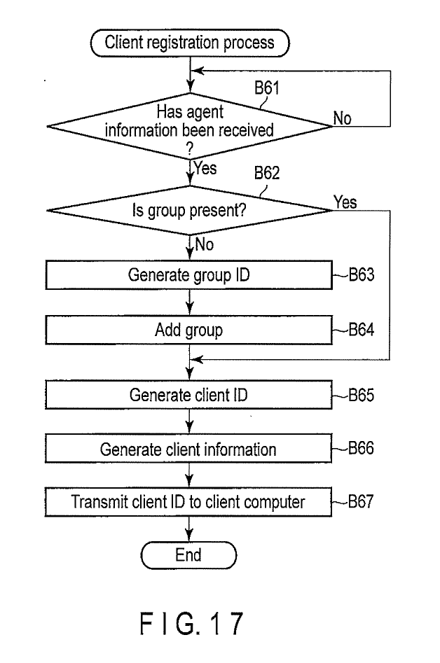

FIG. 17 is a flowchart illustrating an example of the procedure of the client registration process executed by the management server 2.

To start with, the agent information receiver 25 determines whether the agent information transmitted from the client terminal 31 (agent information transmitter 46) has been received (block B61). As described above, the agent information is indicative of the computer name 51A of the client terminal 31, and the group name of the group to which the client terminal 31 belongs. When the agent information has not been received (NO in block B61), the process returns to block B61, and it is determined once again whether the agent information has been received from the client terminal 31.

On the other hand, when the agent information has been received (YES in block 861), the group information generator 22 determines whether the group to which the client terminal 31 belongs is present or not, by using the group information 29B and the agent information (block B62). Specifically, the group information generator 22 determines whether the entry corresponding to the group to which the client terminal 31 belongs is included in the group information 29B stored in the information storage 29. When the group to which the client terminal 31 belongs is present (YES in block B62), the process advances to block 865.

When the group to which the client terminal 31 belongs is not present (NO in block B62), the group information generator 22 generates a group ID of the group to which the client terminal 31 belongs (block B63). Then, the group information generator 22 adds to the group information 298 the entry including the generated group ID and the name of the group (block 864), and advances to block B65.

Subsequently, the client information generator 26 generates a client ID which is to be given to the client terminal 31 which transmitted the agent information (block B65). Then, the client information generator 26 generates client information 29C including the generated client ID and the group ID of the group to which the client terminal 31 belongs (block B66). Specifically, the client information generator 26 generates an entry of the client information 29C which includes the client ID, the computer name of the client terminal 31, and the group ID of the group to which the client terminal 31 belongs. The client information generator 26 adds the generated entry to the client information 290 stored in the information storage 29. In addition, the client ID transmitter 27 transmits the client ID to the client terminal 31 (client ID receiver 47) (block B67).

Incidentally, there is a case in which the agent information includes a group name indicative of a hierarchical structure of the group to which the client terminal 31 belongs. This group name (hierarchical group name) includes, for example, a plurality of group names of groups starting from an uppermost-layer group to a group, to which the client terminal 31 belongs. The hierarchical group name is described in such a format that the plurality of group names are divided by, e.g. a slash mark “/” at each boundary between layers. When such a hierarchical group name is included in the agent information, the group information generator 22 determines, in the order from the upper-layer group, whether the entry corresponding to the group is included in the group information 29B. When the entry corresponding to the group is not included in the group information 29B, the group information generator 22 generates a group ID of this group, and adds to the group information 29B the entry including the generated group ID and the name of the group. In short, in the order from the uppermost-layer group, the process of block B62 to block B64 is repeatedly executed. Thereby, the group information 29B corresponding to the group having the hierarchical structure can be generated by using the group name (hierarchical group name) which is included in the agent information and is indicative of the hierarchical structure of the group to which the client terminal 31 belongs.

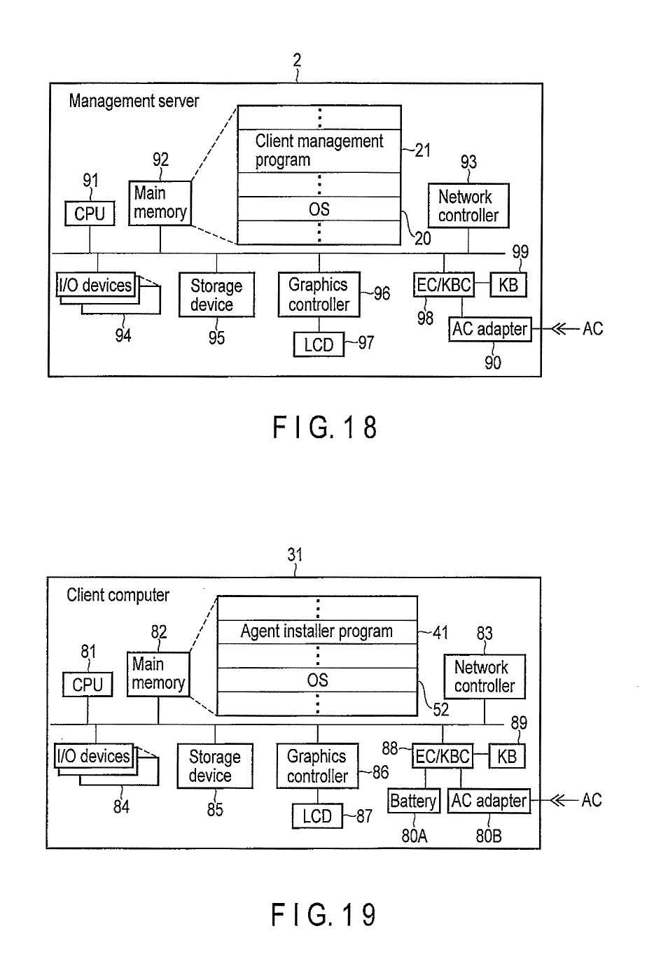

Next, FIG. 18 illustrates an example of the system configuration of the management server 2. The management server 2 includes a central processing unit (CPU) 91, a main memory 92, a network controller 93, I/O devices 94, a storage device 95, a graphics controller 96, a liquid crystal display (LCD) 97, an EC/KBC 98, a keyboard (KB) 99, and an AC adapter 90.

The CPU 91 is a processor for executing various programs. The CPU 91 executes various computing processes, and controls the respective components in the management server 2.

The main memory 92 is a main memory for storing an operating system (OS) 20 and various application programs, such as a client management program 21, which are executed by the CPU 91, and various data. For example, the OS 20 and client management program 21 are loaded in the main memory 92.

The network controller 93 is a wired communication device which executes wired communication of, e.g. the Ethernet® standard, or a wireless communication device which executes wireless communication of, e.g. the IEEE 802.11 standard. By using the network controller 93, the management server 2 communicates with the client terminal 31.

The I/O devices 94 are various input/output devices for inputting/outputting data to/from the management server 2. In addition, the storage device 95 is a nonvolatile storage device for storing various programs and data. The various programs and data stored in the storage device 95 are loaded in the main memory 92 in response to requests by the respective components in the management server 2. The operation of the client management program 21, which is loaded in the main memory 92, is as has been described with reference to FIG. 3, etc.

The graphics controller 96 controls the LCD 97 used as a display monitor of the management server 2. A display signal, which is generated by the graphics controller 96, is sent to the LCD 97. By using the graphics controller 96 and LCD 97, for example, a screen corresponding to an operation by the user is displayed.

The embedded controller/keyboard controller (EC/KBC) 98 is a one-chip microcomputer in which an embedded controller for power management and a keyboard controller for controlling the keyboard 99 and pointing device are integrated. The EC/KBC 98 has a function of powering on/off the management server 2 in accordance with an operation by the user. The EC/KBC 98 supplies power to the respective components in the management server 2 by using power supplied from the outside via the AC adapter 90.

Next, FIG. 19 illustrates an example of the system configuration of the client terminal (client computer) 31. The client terminal 31 includes a central processing unit (CPU) 81, a main memory 82, a network controller 83, I/O devices 84, a storage device 85, a graphics controller 86, a liquid crystal display (LCD) 87, an EC/KBC 88, a keyboard (KB) 89, a battery 80A and an AC adapter 80B.

The CPU 81 is a processor for executing various programs. The CPU 81 executes various computing processes, and controls the respective components in the client terminal 31.

The main memory 82 is a main memory for storing an operating system (OS) 52 and various application programs, such as an agent installer program 41, which are executed by the CPU 81, and various data. For example, the OS 52 and agent installer program 41 are loaded in the main memory 82.

The network controller 83 is a wired communication device which executes wired communication of, e.g. the Ethernet standard, or a wireless communication device which executes wireless communication of, e.g. the IEEE 802.11 standard. By using the network controller 83, the client terminal 31 communicates with the management server 2.

The I/O devices 84 are various input/output devices for inputting/outputting data to/from the client terminal 31. In addition, the storage device 85 is a nonvolatile storage device for storing various programs and data. The various programs and data stored in the storage device 85 are loaded in the main memory 82 in response to requests by the respective components in the client terminal 31. The operation of the agent installer program 41, which is loaded in the main memory 82, is as has been described with reference to FIG. 3, etc.

The graphics controller 86 controls the LCD 87 used as a display monitor of the client terminal 31. A display signal, which is generated by the graphics controller 86, is sent to the LCD 87. By using the graphics controller 86 and LCD 87, for example, a screen corresponding to an operation by the user is displayed.

The embedded controller/keyboard controller (EC/KBC) 88 is a one-chip microcomputer in which an embedded controller for power management and a keyboard controller for controlling the keyboard 89 and pointing device are integrated. The EC/KBC 88 has a function of powering on/off the client terminal 31 in accordance with an operation by the user. The EC/KBC 88 supplies power to the respective components in the client terminal 31 by using power supplied from the outside via the AC adapter 80B or power supplied from the battery 80A.

As has been described above, according to the present embodiment, when a client terminal is managed in units of a group, the group to which the client terminal belongs can easily be registered. In the embodiment, when the group to which the client terminal belongs is to be registered in the management server 2, for example, the administrator of the management server 2 does not input the information for grouping client terminals 3, but the user who uses each client terminal 3 is prompted to select the group to which this computer belongs. Thereby, grouping of client terminals 3 can efficiently be executed. Thus, also in the case where a client terminal that is a target of management is to be newly added, the work by the administrator is not needed, and the cost of management can be reduced.

All the process procedures of this embodiment, which have been described with reference to the flowcharts of FIGS. 12 to 17, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to manage one or more client terminals on a network in units of a group, the apparatus comprising:
a file generator configured to generate a file comprising an installer program, wherein the installer program comprises causing a client terminal to install agent software for managing the client terminal, and causing the client terminal to transmit information indicative of a group, to which the client terminal belongs, to the information processing apparatus;
an information receiver configured to receive, when the installer program is executed with use of the file by a first terminal of the one or more client terminals, first information transmitted from the first terminal, wherein the first information is indicative of a group to which the first terminal belongs; and
a client information generator configured to generate client information comprising information indicative of the first terminal and the first information.

2. The information processing apparatus of claim 1, further comprising a group information generator configured to generate group information which specifies one or more groups,
wherein the file generator is configured to generate the file further comprising the group information, and
the information receiver is configured to receive, when the installer program is executed with use of the file by the first terminal, the first information indicative of a group selected from the one or more groups based on the group information.

3. The information processing apparatus of claim 2, wherein the group information generator is configured to generate the group information which specifies the one or more groups having a hierarchical structure.

4. The information processing apparatus of claim 2, wherein the file generator is configured to generate the file comprising the installer program which further comprises causing the client terminal to display, with use of the group information, a screen for selecting one group from the one or more groups, and causing the client terminal to transmit information indicative of a group selected by using the screen, to the information processing apparatus.

5. The information processing apparatus of claim 1, wherein the information receiver is configured to receive the first information indicative of a name of the group to which the first terminal belongs, and
the information processing apparatus further comprises a group information generator configured to generate group information by using the name of the group, the group information specifying the group to which the first terminal belongs.

6. The information processing apparatus of claim 5, wherein the client information generator is configured to generate the client information in which the information indicative the first terminal and the group information are associated.

7. The information processing apparatus of claim 1, wherein the file generator is configured to generate the file comprising the installer program which further comprises causing the client terminal to transmit a computer name of the client terminal,
the information receiver is configured to further receive a first computer name from the first terminal, and
the client information generator is configured to generate the client information comprising the first computer name and the first information.

8. The information processing apparatus of claim 1, wherein the file generator is configured to generate the file comprising the installer program which further comprises causing the client terminal to transmit a serial number of the client terminal,
the information receiver is configured to further receive a first serial number from the first terminal, and
the client information generator is configured to generate the client information comprising the first serial number and the first information.

9. The information processing apparatus of claim 1, further comprising a notification module configured to notify the first terminal that generation of the client information has been completed.

10. A client management method of managing one or more client terminals on a network in units of a group by a server, the method comprising:
generating a file comprising an installer program, wherein the installer program comprises causing a client terminal to install agent software for managing the client terminal, and causing the client terminal to transmit information indicative of a group, to which the client terminal belongs, to the server;
receiving, when the installer program is executed with use of the file by a first terminal of the one or more client terminals, first information transmitted from the first terminal, wherein the first information is indicative of a group to which the first terminal belongs; and
generating client information comprising information indicative of the first terminal and the first information.

11. A computer-readable, non-transitory storage medium having stored thereon a program which is executable by a computer and causes the computer to manage one or more client terminals on a network in units of a group, the program controlling the computer to execute functions of:
generating a file comprising an installer program, wherein the installer program comprises causing a client terminal to install agent software for managing the client terminal, and causing the client terminal to transmit information indicative of a group, to which the client terminal belongs, to the computer;
receiving, when the installer program is executed with use of the file by a first terminal of the one or more client terminals, first information transmitted from the first terminal, wherein the first information is indicative of a group to which the first terminal belongs; and
generating client information comprising information indicative of the first terminal and the first information.
